(19) United States
(12) Patent Application Publication
(10) Pub. No.: US 2023/0249880 A1
(43) Pub. Date: Aug. 10, 2023

(54) THERMOFORMED TUBE HEAD, TUBE AND MANUFACTURING METHOD

(71) Applicant: AISAPACK HOLDING SA, Vouvry (CH)

(72) Inventors: Jacques THOMASSET, Neuvecelle (FR); Gilles DEMAUREX, Martigny (CH); Rémy CASANOVA, Evian-les-Bains (FR)

(21) Appl. No.: 18/015,142

(22) PCT Filed: Jun. 25, 2021
(86) PCT No.: PCT/IB2021/055680

§ 371 Date: Jan. 9, 2023

(30) Foreign Application Priority Data
Jul. 10, 2020 (EP) 20185275.3

(51) Int. Cl. B65D 35/10; B29C 65/00; B29C 51/42; B29C 51/10; B29L 23/20

(52) U.S. Cl. CPC B65D 35/10; B29C 66/1222; B29C 51/421; B29C 51/10; B29C 66/1224; B29C 66/53247; B29L 2023/20

(57) ABSTRACT

The invention relates to a tube head (1, 2) intended to form a packaging, the head (3, 6) being intended to be welded to a tubular skirt (8, 9) in order to form the said packaging, and the tube head (1 2) being thermoformed from a sheet (20, 21). The invention also relates to a method for manufacturing such a tube head (1, 2) and a tube with said head (3, 6).

### CORRESPONDING APPLICATION

The present application claims priority to earlier EP application No 20185275.3 filed on Jul. 10, 2020 in the name of AISAPACK HOLDING SA, the content of the earlier application being incorporated by reference in its entirety in the present application.

### TECHNICAL FIELD

The present invention relates to a tube head which is thermoformed then welded onto a tubular skirt in order to form a flexible packaging. The present invention applies to the field of packaging, and particularly to that of flexible tubes intended to contain for example creams or pastes such as toothpaste and other similar products (liquid, semi-liquid, pasty etc.). The invention also relates to a thermoforming method for producing this head.

### PRIOR ART

Tube heads produced by moulding have been known for many years, and are described for example in publications WO9115350, EP0059281, FR2322058, GB2191167, U.S. Pat. No. 5,556,678. These moulded heads are simultaneously or subsequently welded onto cylindrical skirts in order to form flexible packagings. One drawback of moulding technologies is associated with the limits of the thicknesses that can be achieved by moulding, as well as the complexity of the technology to be used in order to impart barrier properties to the moulded pieces. Another drawback of moulding technology is associated with the use of highly fluid resins when wishing to produce pieces with a small thickness. The highly fluid resins generally have an inferior resistance to stress cracking, which restricts the selection of the products that these packagings can contain.

Publications U.S. Pat. No. 5,826,737, US20150210456, U.S. Pat. Nos. 5,839,609 and 6,357,631 describe thermoformed packagings which resemble tubes. These packagings have a major drawback associated with their geometry. In contrast to tubes, they cannot be placed upright on their cap and they do not have a flexible cylindrical skirt. In terms of aesthetics and functionality, these packagings consequently have major drawbacks which make them unattractive for the traditional tube market.

The technology of thermoforming is also proposed in publication WO9408860 for producing a refill for detergent in the shape of the tube. This thermoformed refill, which is illustrated in FIG. 1 of the present application, comprises a conical skirt and does not have a reclosable neck. The refill described in this publication WO9408860 does not make it possible to produce reclosable tubes, or tubes with a flexible cylindrical skirt. Another drawback of this packaging is decoration of the skirt, which is difficult because of the conicity and the variable thickness of the said skirt due to the manufacturing method.

It is an object and an aim of the present invention in particular to overcome these difficulties as well as the limitations of the devices presented in the prior art.

A further aim of the present invention is to improve the known products and methods.

### SUMMARY AND PRINCIPLE OF THE INVENTION

The invention relates in particular to a thermoformed tube head, the said head subsequently being welded onto a cylindrical skirt in order to form a packaging such as a tube.

The thermoformed head comprises an external face which forms the exterior and visible part of the packaging. According to the invention, the external face of the head is in contact with the mould during the thermoforming, and therefore highly advantageously has a high precision and reproducibility in comparison with the internal face which lies inside the packaging.

On its periphery, the thermoformed head according to the invention comprises a welding zone on the so-called “external” face, as opposed to the so-called “internal” face which is in contact with the product contained in the packaging. According to the invention, the said external welding zone is used for welding a cylindrical skirt onto the head during the manufacture of the packaging.

According to embodiments of the invention, the thermoformed head comprises a collar on its periphery, the said collar having the aforementioned welding zone on its external face.

According to other embodiments of the invention, the thermoformed head does not comprise a collar on its periphery but still has a welding zone on its periphery and on its external face.

According to embodiments of the invention, the welding zone forms a surface having an axis of symmetry. In one exemplary embodiment of the invention, the welding zone forms a plane perpendicular to the axis of the head. According to another exemplary embodiment, the welding zone forms a conical surface. According to another exemplary embodiment, the welding surface forms a surface of variable curvature. These examples are not limiting, and other shapes and surfaces are possible within the scope of the present invention.

The circumference of the head is preferably circular or of the elliptical type.

The head produced according to some embodiments of the invention preferably has a step on its external face at the limit of the welding zone. This step has a height close and/or comparable to that of the skirt welded onto the head, so that the external surface of the packaging preferably forms a smooth and continuous surface following the welding step.

According to one preferred embodiment, the heads produced are stackable, which facilitates their storage, transport and handling. The stacking of the heads is carried out after the thermoforming operation and the cutting operation, which consists of separating the tube head from the rest of the sheet. The zone of contact between the heads during the stacking is preferably located close to the periphery. In some embodiments, the step which limits the welding zone may also be used as a bearing zone for stacking the heads.

According to some embodiments of the invention, the thermoformed head may comprise an orifice for extracting the product contained in the packaging. In certain cases, the orifice of the head is created by the user during initial opening by a perforation system combined with the cap.

According to some embodiments of the invention, the thermoformed head may be combined with opening/closure means. For example, the head may be combined with caps clipped or screwed onto the head.

According to some embodiments of the invention, the thermoformed head may be combined with tamper-proofing means, for example a welded foil which closes the orifice and is removed during first use. The perforation principle mentioned above may also be used as a tamper-proofing indicator. Other equivalent means may also be employed as a tamper-proofing indicator.

According to some embodiments of the invention, the thermoformed head may be connected by a hinge or any other flexible element made of plastic to the cap in order to form only a single piece. This has an advantage for recycling operations because the cap cannot be separated from the packaging. According to some embodiments, the head and the cap are produced in a single piece during the manufacture by thermoforming.

Some embodiments of the method according to the invention are defined in the claims.

One great advantage of the invention is the possibility of using a multilayer sheet for manufacturing the thermoformed tube head, which makes it possible to obtain excellent barrier properties, for example against moisture and oxygen. Such a result cannot be obtained easily with heads formed by moulding.

According to some embodiments of the invention, the tube head may be produced entirely or partly with recycled material.

Another great advantage of the invention is the possibility of reducing the amount of material used for producing the tube head. According to the invention, the weight reduction is between 25% and 85%, and preferably between 40% and 75%.

Another great advantage of the invention is the possibility of manufacturing printed tube heads at low cost. According to the invention, the sheet used for producing the tube head is printed in a flat state before the thermoforming of the said head. The use of a thermoformed head with printing makes it possible to improve the appearance of the tube and to obtain a tube which is printed not only on the skirt but also on the head.

According to the principles of the invention, the appearance of the tube may be further improved by printing the cap as well, when the latter is produced by thermoforming like the tube head.

The printing of the head and/or the cap may be used, for example, to guarantee the origin or traceability of the tubes because only tubes manufactured by using the principle of the present invention will be able to have such printing of the skirt and the head, as well as the cap at once. This principle may be used to combat counterfeiting for example.

According to some embodiments of the invention, the tube head is manufactured by a thermoforming method characterized in that the said “external” face of the tube head, which is optionally printed, is in contact with the mould during the thermoforming operation. The face referred to as the external face has greater precision than the so-called “internal” face of the tube head because of the thermoforming mould. According to this method, the heating of the sheet prior to the thermoforming is preferably carried out from the side of the sheet which is not printed. In general, this heating is carried out by infrared radiation. Other equivalent methods are of course possible.

According to some embodiments of the invention, the tube head is combined with an opening/closure system, which may be a cap. This cap may be manufactured by injection moulding or by thermoforming, or another equivalent method.

According to some embodiments of the invention, when the cap is manufactured by thermoforming, it has an optionally printed so-called “external” face of which the geometrical precision is less than that of the so-called “internal” face of the cap. Consequently, in the method for thermoforming the cap, the internal face of the cap is in contact with the mould in order to permit this geometrical precision of the internal face. In this method, the heating of the sheet prior to the thermoforming operation is also preferably carried out from the unprinted side of the said sheet.

According to some embodiments of the invention, the internal face of the cap cooperates with the external face of the head in order to close the packaging in a leaktight fashion, as well as to open the packaging.

In an embodiment, the invention concerns a tube head intended to form a packaging, said head being intended to be welded to a tubular skirt in order to form said packaging, wherein said head is thermoformed from a sheet.

In embodiments the head comprises an external face and an internal face, said internal face being intended to be in contact with the product contained in the packaging, said head comprising on its periphery a welding zone located on its external face for welding of said skirt.

In embodiments the welding zone is preferably on a collar.

In embodiments the head preferably comprises a step at the limit of the welding zone.

In embodiments the step preferably has a height close to the thickness of the skirt, making it possible to obtain a smooth surface when the head and the skirt are assembled.

In embodiments the step may be used as a bearing zone when stacking tube heads.

In embodiments the head forms only a single piece with a cap.

In embodiments the head comprises an orifice for extracting the product contained in the tube.

In embodiments the head comprises tamper-proofing means such as a foil or other equivalent means.

In embodiments the sheet is a single-layer or multilayer sheet.

In embodiments the sheet is printed before the thermoforming.

In embodiments the cap is also printed before its thermoforming.

In embodiments the invention concerns a tube comprising at least one skirt and a tube head as defined in the present application.

In embodiments, the invention concerns a method for manufacturing a packaging tube using a head as defined in the present application which is welded to a skirt.

In embodiments the method comprises the provision of a sheet and the conversion of at least a part of the sheet into a head by thermoforming.

In embodiments the sheet is provided by unrolling a spool or by extrusion.

In embodiments the sheet is heated to the thermoforming temperature, the tube head is thermoformed in the cavity of a mould so that the external face of the tube head, forming the external face of the packaging, is in contact with the mould, and the tube head is cut and separated from the rest of the sheet.

In embodiments the sheet is heated prior to the thermoforming operation.

In embodiments the sheet is heated homogeneously or inhomogeneously.

In embodiments a pressure difference is preferably applied between each side of the sheet.

In embodiments a die is preferably applied against the sheet in order to deform it.

In embodiments a cap is preferably formed in a single piece with the head from the same sheet by thermoforming.

In embodiments the sheet is a single-layer or multilayer sheet.

In embodiments the sheet is printed before the thermoforming operation.

In embodiments the external face of the tube head is preferably in contact with a mould during the thermoforming operation.

In embodiments the internal face of the cap is preferably in contact with a mould during the thermoforming operation.

### BRIEF DESCRIPTION OF THE DRAWINGS

FIG. 1 illustrates an example of thermoformed packaging according to the prior art;

FIGS. 2 to 7 illustrate exemplary embodiments of thermoformed tube heads according to the invention. The tube heads are presented in section, and only one half is represented because of the symmetry with respect to the axis.

FIGS. 8 to 11 illustrate examples of welding of tube skirts onto the thermoformed tube heads according to the invention. The figures show the peripheral parts of the tube shoulders.

FIGS. 12 and 13 show examples of the necks and orifices of thermoformed heads according to the invention;

FIG. 14 illustrates an example of a thermoformed cap which may be combined with the tube head according to the invention.

FIGS. 15 and 16 illustrate examples of closure of the packaging;

FIG. 17 illustrates a thermoformed tube head according to the invention which can be stacked easily.

FIG. 18 illustrates the stacking of the thermoformed head described in FIG. 17.

FIGS. 19 to 21 illustrate a variant of the invention in which the head according to the invention comprises the closure system.

FIGS. 22 to 24 illustrate an example of the thermoforming method for manufacturing the thermoformed heads according to the invention.

### DETAILED DESCRIPTION

1: tube head
2: head
3: welding zone
4: step
5: closure means of the head
6: orifice
7: collar
8: skirt
9: external face
10: internal face
11: end forming the orifice
12: cap
13: closure means of the cap
15: gripping means
16: external face of the cap
17: internal face of the cap
18: means for facilitating the perforation
19: thermoforming mould
20: sheet
21: holding clamp
22: channels for evacuating air

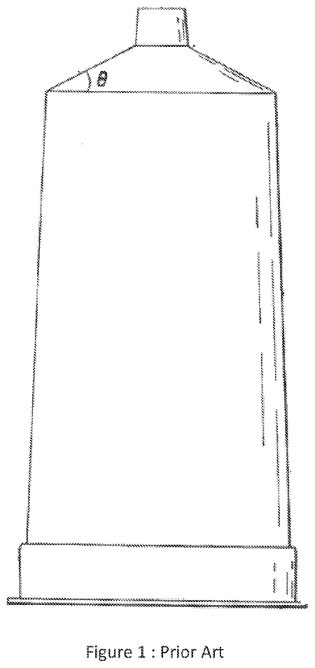

FIG. 1 illustrates an example of thermoformed packaging according to the prior art.

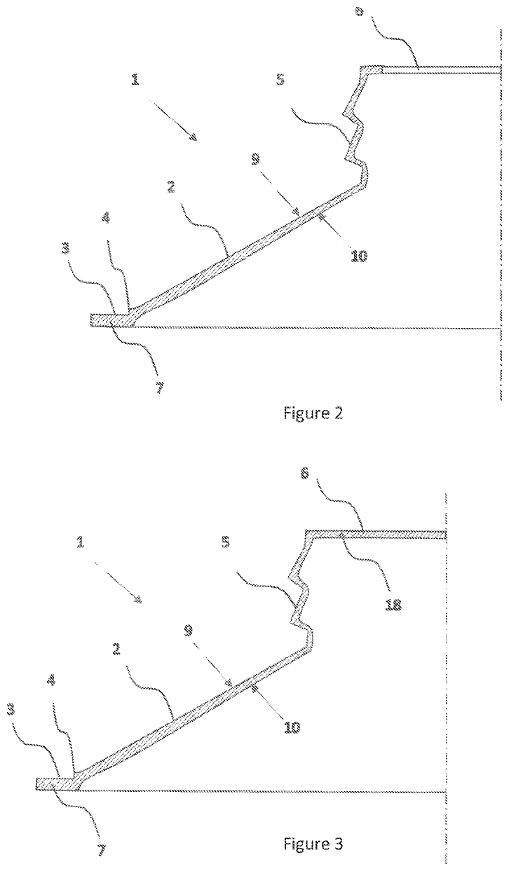

FIGS. 2 to 7 illustrate exemplary embodiments of thermoformed tube heads according to the invention. The tube heads are presented in section, and only one half is represented because of the symmetry with respect to the axis.

FIG. 2 illustrates one embodiment of a tube head 1 produced by thermoforming, the said tube head 1 comprising a collar 7 on its periphery with a welding zone 3 limited by a step 4, as well as an orifice 6 in its central part, opening/closure means 5 and a conical shoulder 2. The opening/closure means 5 are for example snap-fastening or screwing elements, or the like. The external face 9 of the tube head 1 is in contact with the thermoforming mould during the manufacturing method, the effect of which is that the external face 9 can have a greater geometrical precision than the internal face 10.

FIG. 3 illustrates another embodiment of a tube head according to the invention having an orifice 6; the said orifice being intended to be formed by piercing using an appropriate cap. The said orifice 6 preferably comprises means 18 for facilitating the perforation. The means for facilitating the perforation are, for example, partial precutting of the orifice, which may be carried out before, during or after the thermoforming operation. Other means for facilitating the perforation of the orifice may be envisaged, such as for example a reduced thickness of the wall of the tube head in the perforated zone.

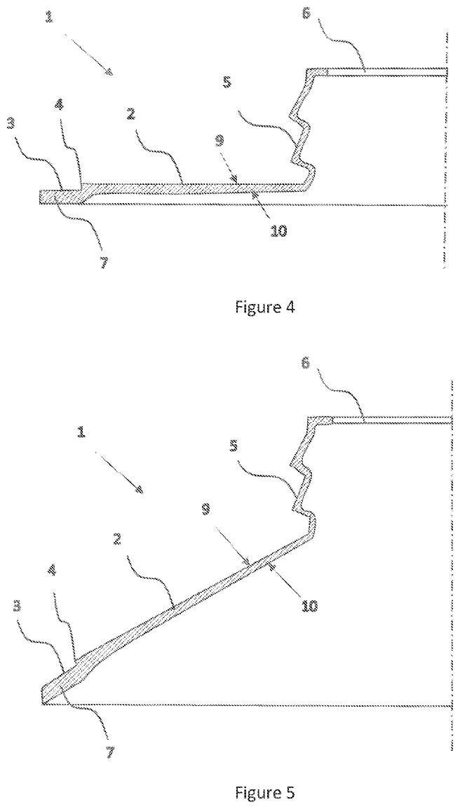

FIG. 4 illustrates another embodiment, in which the tube head has a flat shoulder 2.

FIG. 5 illustrates an embodiment of a tube head 1 comprising a welding zone 3, which forms a conical surface and is delimited by a step 4. The collar 7 of the tube head also has a conical geometry. According to one preferred embodiment of the invention, the conical geometry of the collar is created during the thermoforming method because of the geometry of the holding clamp 21 which holds the sheet during the thermoforming operation. As an alternative, the collar may be formed before or after the thermoforming operation.

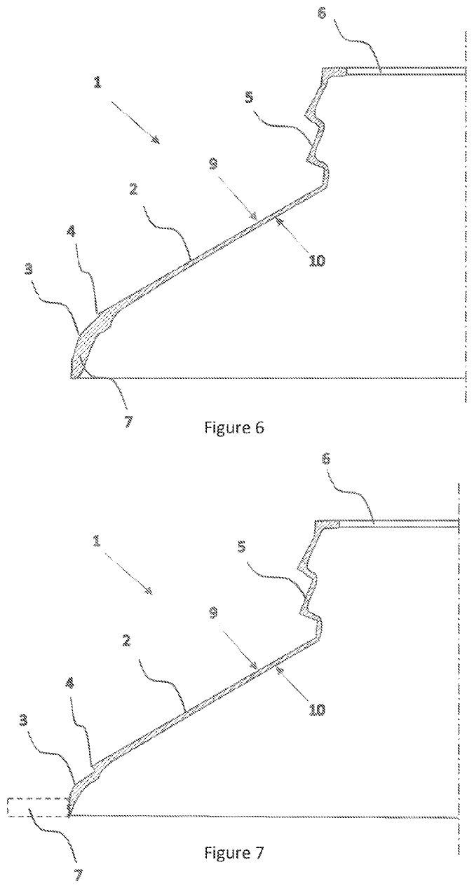

FIG. 6 illustrates another geometry of the welding zone 3 and of the collar 7.

FIG. 7 illustrates the case in which the collar 7 is separated from the tube head after the thermoforming of the said head. This solution is advantageous for reducing the mass of the tube head. The separation of the collar is carried out by a cutting operation, which may be performed in the thermoforming tool or afterwards.

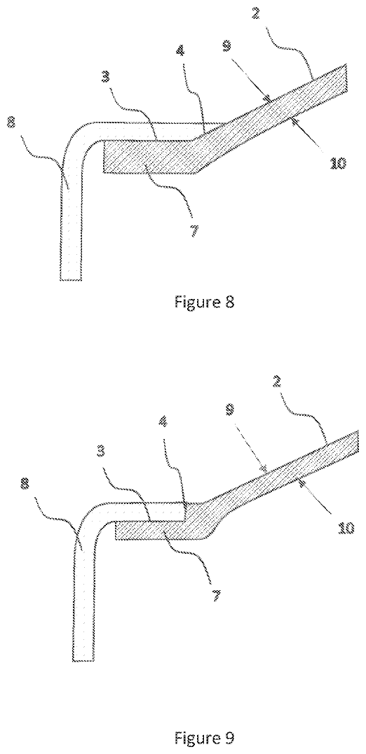

FIGS. 8 to 11 illustrate embodiments of welding of tube skirts 8 onto the thermoformed tube heads 1 according to the invention. The figures show the peripheral parts of the tube shoulders.

FIG. 8 illustrates an embodiment of welding of the skirt 8 onto the tube head 1 in the welding zone 3 in the particular case in which the collar 7 forms a horizontal plane. The skirt 8 is welded onto the external face 9 of the tube head. The step 4 is located in the extension of the surface of the shoulder 9, so that after assembly the skirt and the tube head form an external surface without protuberance in the welding zone.

FIG. 9 illustrates another embodiment of welding of the skirt 8 onto the tube head 1. In this example, the collar 7 of the tube head 1 comprises a step 4 at the end of the welding zone 3, which makes it possible to obtain a smooth external surface after welding of the skirt 8. According to the invention, the welding zone 3 and the step 4 are produced before, during or after the thermoforming operation. One preferred production method consists of using the geometry of the holding clamp 21 in order to form the welding zone 3 and the step 4 at the collar, after heating of the sheet.

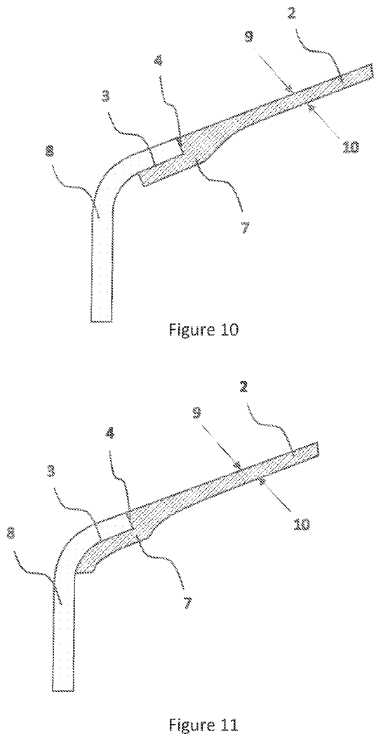

FIG. 10 illustrates one embodiment of the welding of the skirt 8 onto the collar 7 in the welding zone 3, forming a conical surface.

FIG. 11 illustrates the welding of the skirt 8 onto the collar 7, which has a welding zone 3 forming a surface of variable curvature delimited by a step 4.

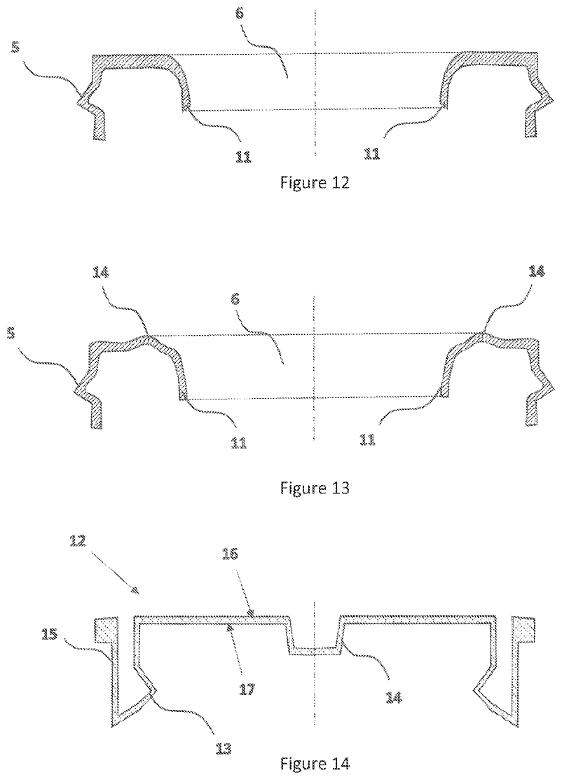

FIGS. 12 and 13 show examples of the necks and orifices of thermoformed heads according to the invention.

FIG. 12 illustrates one preferred embodiment of the neck, in which the end 11 of the wall forming the orifice 6 is set back towards the inside of the tube head 1, that is to say towards the inside of the packaging. Setting back the ends 11 towards the inside makes it possible to form a sealing zone when the orifice is closed by a cap. According to the invention, the ends 11 are set back towards the interior before, at the same time as or after the operation of cutting out the orifice.

FIG. 13 illustrates the part of the tube head which is close to the orifice 6 and comprises additional sealing means 14 on its external face 9, the said sealing means being compressed by the cap when closing the tube. Said sealing means maybe a shape or additional material or a seal, gasket etc.

FIG. 14 illustrates an embodiment of a thermoformed cap 12 which may be combined with a tube head 1 according to the invention. The cap 12 comprises gripping means 15, closure means 13 and sealing means 14. The closure means 13 are, for example, snap-fastening or screwing means. The internal face 17 of the said cap 12, which is in contact with the mould during the thermoforming operation, has a greater precision than the external face 16 of the said cap 12.

According to the invention, the external face 16 of the cap may be decorated by printing the sheet in the flat state before thermoforming.

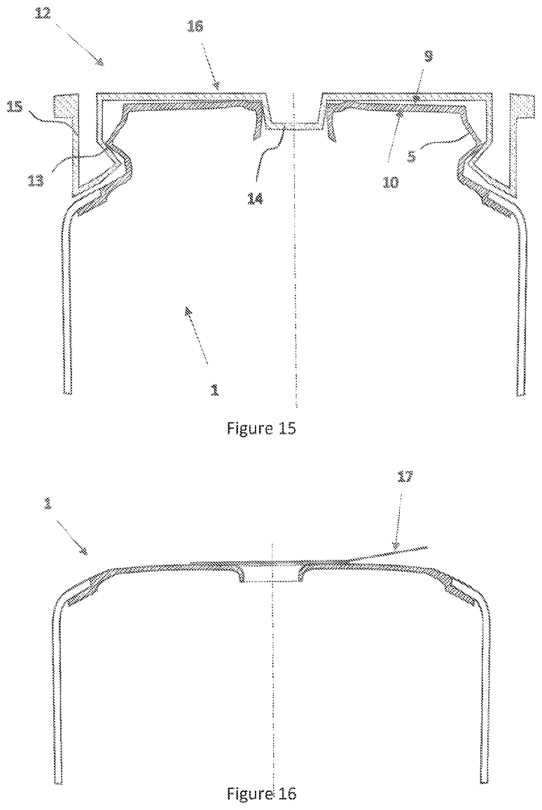

FIGS. 15 and 16 illustrate embodiments of closures of the packaging.

FIG. 15 illustrates a first embodiment of closure of the tube head 1 by a cap 15; the said tube head 1 and the said cap 15 being produced by thermoforming according to the invention. The respective opening/closure means 5 and 13 as well as the sealing means 14 of the tube head 1 and of the cap 15 cooperate during opening and closing operations. According to the invention, the external face 13 of the tube head 1 with a high precision matches with the internal face 17 of the cap, which also has a high precision.

FIG. 16 illustrates an embodiment of closure of the tube head 1 using a foil 17. According to one embodiment, the foil 17 is fully separated from the packaging when opening. According to one preferred embodiment, a peelable and repositionable foil allows successive opening and closing of the tube head 1. According to this preferred embodiment, the foil 17 cannot be fully separated from the tube head because of a part of the foil which is fixed onto the tube head 1.

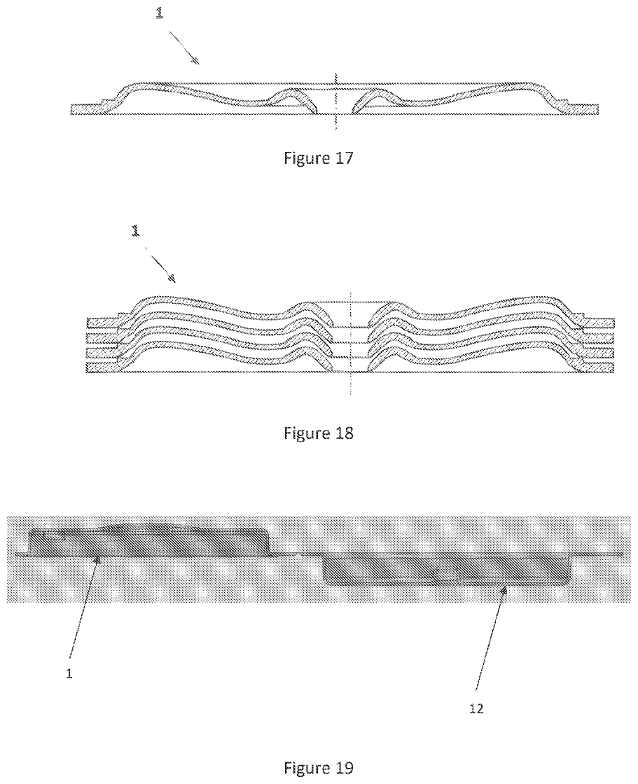

FIG. 17 illustrates a thermoformed tube head 1 according to one embodiment of the invention, which can be stacked easily. Stacking of the tube heads is a great advantage for their transport, handling, storage and removal from storage in the methods for manufacturing the packaging.

FIG. 18 illustrates the stacking of the thermoformed head 1 described in FIG. 17. The stacking of the tube heads 1 is carried out using contact between the tube heads 1 close to their periphery. In the example illustrated in FIG. 17, the step 4 of the tube head 1 is used to create the spacing of the stacked pieces.

FIGS. 19 to 21 illustrate a variant of the invention in which the head according to the invention comprises the closure system.

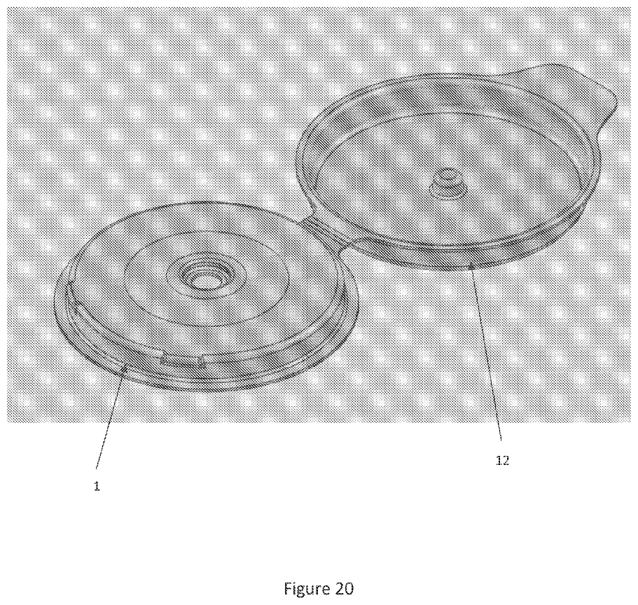

FIGS. 19 and 20 illustrate the tube head 1 comprising its closure system in the open position; the said open position also being the position in which the tube head 1 is thermoformed.

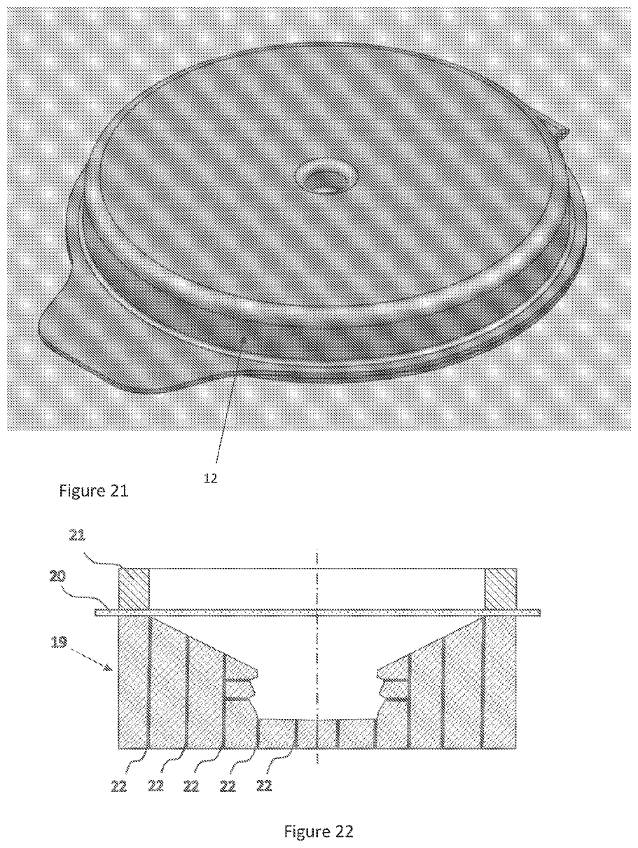

FIG. 21 illustrates the tube head 1 comprising its closure system in the closed position.

The method for thermoforming the tube head according to the invention is illustrated in FIGS. 22 to 24 and comprises at least the following operations in succession:
1. unrolling a sheet 20 packaged on spools
2. heating the sheet 20 to the thermoforming temperature
3. thermoforming the tube head in the cavity of a mould 19 so that the external face 9 of the tube head, which forms the external face 9 of the packaging, is in contact with the mould 19
4. cutting the tube head and separating it from the rest of the sheet 20.

One alternative method consists of replacing operations 1 and 2 above with a first operation of extruding the sheet 20 then a thermal second operation consisting of bringing the sheet 20 to the thermoforming temperature. The thermal operation is slightly different because, in the alternative method, excessive cooling of the extruded material for bringing it to the thermoforming temperature is avoided. The thermal operation in the scope of this alternative method may be either cooling or slight heating, or a combined effect of heating and cooling. The alternative method makes it possible to reduce the energy associated with the heating of the sheet.

Advantageously, the scraps of the sheet 20 resulting from the thermoforming are recycled into one of the layers of the said sheet.

FIG. 22 illustrates the sheet 20 in the thermoforming mould 19 before the thermoforming operation. The sheet 20, which may be a single-layer or multilayer sheet, has been heated beforehand according to known methods such as heating by radiation, heating by contact or heating by convection. Preferably, the sheet is heated by infrared radiation. The surface of the sheet may be heated homogeneously or, conversely, in a targeted fashion in order to promote deformation of the sheet in preferred zones.

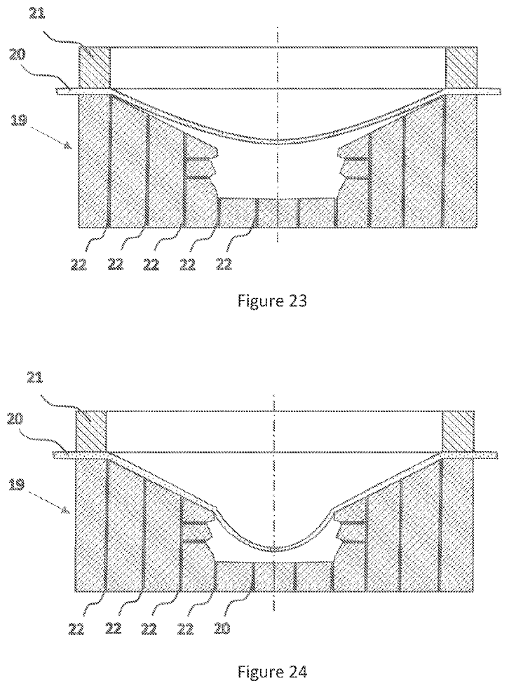

FIG. 23 illustrates the deformation of the sheet 20 in the thermoforming mould 19, which is associated with a pressure difference between the two sides of the sheet 20. In general, the pressure difference is applied by suction of the air trapped between the sheet 20 and the cavity of the mould 19; the air being sucked through the channels 22. One alternative method consists of applying a positive pressure on the opposite side of the sheet 20 from the channels 22 and in removing the air trapped in the cavity by using the channels 22. Another alternative method consists of using a die which, under the effect of its movement, deforms the sheet 20 before or at the same time as the deformation of the sheet by an air pressure difference.

FIG. 24 illustrates another example of deformation of a sheet 20 during the thermoforming method. FIG. 24 illustrates in particular the deformation of the sheet 20 in order to form the neck of the tube head.

The thermoforming operation may require additional operations, for example shaping the collar 7 and the welding zone 3, or such as forming the step 4, or alternatively deforming and setting back the ends 11 of the orifice.

The steps of cutting out the orifice and separating the head are carried out according to the known methods of sheet cutting by means of tools for cutting by compression or shearing.

The described embodiments are described by way of illustrative examples and should not be regarded as limiting. For example, other embodiments may employ means equivalent to those described. The embodiments and characteristics or steps thereof may also be combined with one another, depending on the circumstances, or means used in one embodiment may be used in another embodiment.

1. Tube head intended to form a packaging, said head being intended to be welded to a tubular skirt in order to form said packaging, wherein said head is thermoformed from a sheet.

2. Tube head according to claim 1, wherein said head comprises an external face and an internal face, said internal face being intended to be in contact with the product contained in the packaging, said head comprising on its periphery a welding zone located on its external face for welding of said skirt.

3. Tube head according to claim 1, wherein said welding zone is on a collar.

4. Tube head according to claim 1, wherein said head comprises a step at the limit of the welding zone.

5. Tube head according to claim 1, wherein said step has a height close to the thickness of the skirt, making it possible to obtain a smooth surface when the head and the skirt are assembled.

6. Tube head according to claim 1, wherein said step is used as a bearing zone when stacking tube heads.

7. Tube head according to claim 1, wherein said head forms only a single piece with a cap.

8. Tube head according to claim 1, wherein said head comprises an orifice for extracting the product contained in the tube.

9. Tube head according to claim 1, wherein said head comprises tamper-proofing means.

10. Tube head according to claim 1, wherein the sheet is a single-layer or multilayer sheet.

11. Tube head according to claim 1, wherein said sheet is printed before the thermoforming.

12. Tube head according to claim 1, wherein the cap is also printed before its thermoforming.

13. Tube comprising at least one skirt and a tube head as defined in claim 1.

14. Method for manufacturing a packaging tube using a head as defined in claim 1, which is welded to a skirt.

15. Method for manufacturing a tube head for a packaging, said method comprising the provision of a sheet and the conversion of at least a part of the sheet into said head by thermoforming.

16. Method according to claim 15, wherein the sheet is provided by unrolling a spool or by extrusion.

17. Method according to claim 15, wherein the sheet is heated to the thermoforming temperature, the tube head is thermoformed in the cavity of a mould so that the external face of the tube head, forming the external face of the packaging, is in contact with the mould, and the tube head is cut and separated from the rest of the sheet.

18. Method according to claim 15, wherein the sheet is heated prior to the thermoforming operation.

19. Method according to claim 18, wherein the sheet is heated homogeneously or inhomogeneously.

20. Method according to claim 15, wherein a pressure difference is applied between each side of the sheet.

21. Method according to claim 15, wherein a die is applied against the sheet in order to deform it.

22. Method according to claim 15, wherein a cap is formed in a single piece with the head from the same sheet by thermoforming.

23. Method according to claim 15, wherein the sheet is a single-layer or multilayer sheet.

24. Method according to claim 15, wherein the sheet is printed before the thermoforming operation.

25. Method according to claim 15, wherein the external face of the tube head is in contact with a mould during the thermoforming operation.

26. Method according to claim 15, wherein the internal face of the cap is in contact with a mould during the thermoforming operation.
